(19) United States
(12) Patent Application Publication
(10) Pub. No.: US 2008/0027765 A1
(43) Pub. Date: Jan. 31, 2008

(54) METHODS AND SYSTEMS FOR VENDING AIR TRAVEL SERVICES

(75) Inventors: Gerald Gunn, Vancouver (CA); Guylaine Lavoie, Saint-Lambert (CA)

Correspondence Address: DARBY & DARBY P.C., P.O. BOX 770, Church Street Station, New York, NY, 10008-0770, US

(73) Assignee: Air Canada, Dorval, CA (US)

(21) Appl. No.: 11/551,844

(22) Filed: Oct. 23, 2006

Related U.S. Application Data
(60) Provisional application No. 60/820,553, filed on Jul. 27, 2006.

(51) Int. Cl. G06Q 10/00

(52) U.S. Cl. 705/5

(57) ABSTRACT

A computer-implemented method of vending air travel services comprises determining a plurality of published fares each associated with a respective one of a plurality of root booking classes, said published fares being applicable to the purchase of air travel at a root service level. The method further comprises determining a plurality of derived fares each associated with a respective equivalent booking class that is one of the root booking classes, said derived fares being applicable to the purchase of air travel at a non-root service level, the derived fare for which the equivalent booking class is a particular one of the root booking classes being computed from the published fare associated with the particular one of the root booking classes by applying a price differential that is common across multiple ones of the root booking classes. The method further comprises offering the sale of air travel at a plurality of price points that includes at least a first one of the published fares and at least a first one of the derived fares, wherein the equivalent booking class associated with said first one of the derived fares corresponds to the root booking class associated with said first one of the published fares.

### CROSS-REFERENCE TO RELATED APPLICATION

The present application claims the benefit under 35 USC §119(e) of U.S. provisional patent application Ser. No. 60/820,553, filed on Jul. 27, 2006, hereby incorporated by reference herein.

### FIELD OF THE INVENTION

The present invention relates generally to the vending of air travel services and, more specifically, to methods and systems for providing greater price predictability and transparency to customers during the process of purchasing air travel services.

### BACKGROUND

Recently, airlines have come under pressure from discount carriers offering passengers all ability to travel with virtually no services on-board. Recognizing that this level of travel is below their standard economy cabin class, incumbent airlines have begun the process of splitting their economy cabin class offering into a “lower-service-level” economy cabin class and a “higher-service-level” economy cabin class. The lower-service-level economy cabin class and the higher-service-level economy cabin class provide different levels of service (e.g., with respect to change policy, advanced seat selection, etc.) while vying for the same inventory of seats on an aircraft. By offering multiple service levels within economy cabin class, an airline is able to compete with discount carriers while increasing profitability, and without any impact on the cabin design of their aircraft.

Assuming therefore the existence of a lower-service-level economy cabin class and a higher-service-level economy cabin class, consider two hypothetical passengers sitting side by side on an aircraft. If the tickets were purchased at different service levels, the two passengers will expect to have paid a different amount for their respective tickets; however, because the two passengers are still seated in economy cabin class, both passengers will tend to be sensitive to price differences, and will expect some degree of price predictability and transparency between the two levels of economy cabin class.

However, airlines currently do not offer adequate price predictability or transparency to passengers in this regard. In other words, the price difference between a lower-service-level economy cabin class ticket and a higher-service-level economy cabin class ticket remains arbitrary from the perspective of the passenger, and the manner in which it is derived is perceived by passengers as mysterious at best. As a result, passengers may tend to feel that they are overpaying when purchasing a higher-service-level economy cabin class ticket, and hence, over time, may become less likely to purchase higher-service-level economy cabin class tickets. This will tend to drive down the profitability gains and competitiveness that incumbent airlines were hoping to achieve with the introduction of multiple levels of economy cabin class.

Against this background, there is clearly a need in the industry to provide greater price predictability and transparency to customers during the process of purchasing air travel services, while maximizing an airline's flexibility in offering multiple price points for economy cabin class travel.

### SUMMARY OF THE INVENTION

A first broad aspect of the present invention seeks to provide a computer-implemented method of vending air travel services, comprising: determining a plurality of published fares each associated with a respective one of a plurality of root booking classes, said published fares being applicable to the purchase of air travel at a root service level; determining a plurality of derived fares each associated with a respective equivalent booking class that is one of the root booking classes, said derived fares being applicable to the purchase of air travel at a non-root service level, the derived fare for which the equivalent booking class is a particular one of the root booking classes being computed from the published fare associated with the particular one of the root booking classes by applying a price differential that is common across multiple ones of the root booking classes; and offering the sale of air travel at a plurality of price points that includes at least a first one of the published fares and at least a first one of the derived fares, wherein the equivalent booking class associated with said first one of the derived fares corresponds to the root booking class associated with said first one of the published fares.

A second broad aspect of the present invention seeks to provide a computing device suitable for use in facilitating the purchase of air travel services, the computing device comprising: means for determining a plurality of published fares each associated with a respective one of a plurality of root booking classes, said published fares being applicable to the purchase of air travel at a root service level; means for determining a plurality of derived fares each associated with a respective equivalent booking class that is one of the root booking classes, said derived fares being applicable to the purchase of air travel at a non-root service level, the derived fare for which the equivalent booking class is a particular one of the root booking classes being computed from the published fare associated with the particular one of the root booking classes by applying a price differential that is common across multiple ones of the root booking classes; and means for offering the sale of air travel at a plurality of price points that includes at least a first one of the published fares and at least a first one of the derived fares, wherein the equivalent booking class associated with said first one of the derived fares corresponds to the root booking class associated with said first one of the published fares.

A third broad aspect of the present invention seeks to provide a database suitable for use in the vending of air travel services on a given flight, said database comprising a plurality of logical records storing data pertaining to a first service level and data pertaining to a second service level. The data pertaining to the first service level conveys information indicative of: a respective published fare provided to a gathering and redistribution entity in association with a respective one of a plurality of root booking classes for the given flight; the respective published fare being applicable to the purchase of air travel on the given flight at the first service level. The data pertaining to the second service level conveys information indicative of: a respective equivalent root booking class that is one of said plurality of root booking classes; a respective derived fare; a corresponding second published fare provided to a gathering and redistribution entity in association with a corresponding non-root booking class for the given flight; the respective derived fare being applicable to the purchase of air travel on the given flight at the second service level; the respective derived fare being derived from the corresponding second published fare by applying an adjustment that is a function of the respective equivalent root booking class.

A fourth broad aspect of the present invention seeks to provide a computer-implemented method of vending air travel services, comprising: receiving air travel parameters from a user; identifying at least one flight that is in accordance with the air travel parameters; and providing the user with an opportunity to purchase a ticket for at least one of said at least one flight at either a respective first fare associated with a first service level or a respective second fare associated with a second service level; wherein the respective first and respective second fares are selected from a database of fares as a function of prevailing purchase conditions; wherein the respective first and respective second fares differ by an amount that is independent of the prevailing purchase conditions.

A fifth broad aspect of the present invention seeks to provide a system for vending air travel services, comprising: means for receiving air travel parameters from a user; means for identifying at least one flight that is in accordance with the air travel parameters; and means for providing the user with an opportunity to purchase a ticket for at least one of said at least one flight at either a respective first fare associated with a first service level or a respective second fare associated with a second service level; wherein the respective first and respective second fares are selected from a database of fares as a function of prevailing purchase conditions; wherein the respective first and respective second fares differ by an amount that is independent of the prevailing purchase conditions.

A sixth broad aspect of the present invention seeks to provide a method of vending air travel services, comprising: determining for a given flight a plurality of published fares respectively associated with a plurality of booking classes, said published fares being applicable to the purchase of air travel on the given flight under different purchase conditions associated with the plurality of booking classes; and offering the sale of air travel on the given flight at a number of price points that exceeds the number of published fares in said plurality of published fares.

A seventh broad aspect of the present invention seeks to provide a computer-implemented method of vending air travel services, comprising: receiving air travel parameters from a user; identifying a flight that is in accordance with the air travel parameters; providing the user with an opportunity to make a first decision, said first decision being a decision to purchase a ticket for said flight at either a first fare associated with a first service level or a second fare associated with a second service level; responsive to said user conveying an intent to purchase a ticket for said flight at the first service level, compelling the user to make a second decision, said second decision being a decision to accept or reject an opportunity to purchase a ticket for said flight at the second service level instead of at the first service level; and selling the ticket at the first fare or the second fare as a function of an outcome of the second decision.

An eighth broad aspect of the present invention seeks to provide a computing device suitable for use in facilitating the purchase of air travel services by a user, the computing device comprising: means for receiving air travel parameters from a user; means for identifying a flight that is in accordance with the air travel parameters; means for providing the user with an opportunity to make a first decision, said first decision being a decision to purchase a ticket for said flight at either a first fare associated with a first service level or a second fare associated with a second service level; means responsive to said user conveying an intent to purchase a ticket for said flight at the first service level, for compelling the user to make a second decision, said second decision being a decision to accept or reject an opportunity to purchase a ticket for said flight at the second service level instead of at the first service level; and means for selling the ticket at the first fare or the second fare as a function of an outcome of the second decision.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram depicting the configuration of an architecture for vending air travel services, in accordance with an embodiment of the present invention;

FIG. 2 illustrates an example of an introductory page for allowing a user to specify air travel parameters;

FIG. 3 illustrates an example of a select page for allowing the user to select a flight from a plurality of flights for one or more origin-destination segments;

FIG. 4 illustrates an example of a review page for allowing the user to proceed with payment for a selected set of flights, or to make a service level change based on a price incentive, in accordance with an embodiment of the present invention;

FIG. 5 illustrates an example of a dialog box for compelling the user to make a decision as to whether or not to effect a service level change, in accordance with an embodiment of the present invention; and

FIG. 6 illustrates a fare database that is suitable for use in the architecture of FIG. 1.

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

In order to give an airline a certain degree of flexibility in charging for air travel and thereby to optimize management of the airline's revenue, the pricing structure for seats on a given flight is characterized by a set of “booking classes”. It is customary in the air travel industry to allocate single letters of the alphabet to the booking classes.

The booking classes are divided amongst one or more cabin classes and, furthermore, amongst one or more “service levels” in each cabin class. A “service level” is characterized by a collection of core service attributes that apply to all travel effected at that service level. For example, a same-day airport change may be a feature that incurs a fee at one service level, while being a core service attribute at another service level. Other features that may be core service attributes at some service levels but not at others include, without limitation: flight changes, possibility of same day standby, entitlement to a refund, priority check-in, advance seat selection, surcharge for sports equipment, frequent flyer miles multiplier (e.g., 0.5, 1.0, 1.5), and the like. In addition, certain service levels may be associated with “privileges” that are not core service attributes in themselves, but instead are obtainable at those service levels by paying a surcharge. More specifically, a privilege refers to a feature that is available by paying a surcharge at one service level, but otherwise remains unavailable at another service level, even if one were willing to pay the surcharge associated with the privilege in question. Examples of such privileges include, without limitation: VIP lounge access, meal vouchers and parking, to name a few.

In addition, each booking class is associated with a respective “published fare” and has a number of available seats allocated thereto. The rules that govern the number of available seats per booking class and the published fare associated with each booking class can be provided by an inventory management function. Various factors may be taken into consideration by the inventory management function when determining the published fare associated with a given booking class for travel on a given flight. These include, without limitation: day of the week, seasonality (e.g., Christmas, Spring Break, etc.), whether the time period between the outbound and inbound flights spans a Saturday night (particularly for international flights), how close the date of purchase is to the date of travel, whether there is a connecting flight through a certain preferential airport, and so on. Thus, the number of published fares and booking classes for the given flight can account for a wide range of purchase conditions.

The airline chooses how to distribute the available booking classes amongst the service levels it offers and allocates a published fare to each of the booking classes. The airline sends the published fare associated with each booking class to a fare gathering and redistribution entity, a non-limiting example of which is the Airline Tariff Publishing Company (ATP) (for more information, see http://www.atpco.net). At the fare gathering and redistribution entity, the published fares received from various airlines are compiled, monitored and redistributed among member airlines. The published fares for a given flight may be updated and republished on a daily or weekly basis, for example.

Due to the twenty-six (26) letter limit of the alphabet, which may practically amount to an even smaller number of available letters due to certain booking classes being reserved, airlines need to provide different price granularity at different service levels competing for the same inventory of seats. Typically, one service level will be allocated greater price granularity than any other service level, and as such there will be an unequal proportion of booking classes allocated to different service levels. Thus, a one-to-one correspondence may not exist between the booking classes allocated to one service level and the booking classes allocated to another service level.

In fact, where there are N service levels, and the number of booking classes allocated to a single service level exceeds 26/N, one cannot ensure a one-to-one correspondence between all booking classes amongst all service levels. For example, if it is assumed that a total of five (5) or more out of the available twenty-six (26) booking classes are unusable, obsolete or reserved, it follows that when the number of service levels competing for the same inventory of seats is three or more, then there are not enough available letters to allow more than seven (7) respective booking classes to be allocated to each of the three service levels.

It should also be appreciated that the airline is not bound to quote a user the published fare associated with the booking class most applicable to the purchase conditions prevailing at the time of purchase. In fact, the airline may discount the published fare by an amount, hereinafter referred to as a “discount”. More specifically, and as will now be described in greater detail, by determining plural booking classes that apply to the purchase conditions prevailing at the time of purchase (i.e., one for each existing service level), and by applying a discount to the published fare associated with one or more of these booking classes, the airline can compute a “derived fare” for each of the other booking classes, which are ultimately quoted to the user. (In other cases, not discussed in further detail, the airline may increase rather than decrease the published fare, and therefore it may sometimes be appropriate to refer to the amount generally as an “adjustment” to the published fare.)

To this end, embodiments of the present invention provide a set of “root” booking classes allocated to a “root” service level, as well as sets of “non-root” booking classes respectively allocated to one or more non-root service levels. In accordance with a specific non-limiting embodiment, each of the one or more non-root service levels can be higher or lower than the root service level. In accordance with a non-limiting embodiment, the number of non-root booking classes per non-root service level can be less than the number of root booking classes, thereby to allow the root booking classes to achieve sufficiently fine price granularity at the root service level; in fact, it is within the scope of the present invention to provide even only a single non-root booking class per non-root service level, thereby maximizing the available number of root booking classes (and enhancing the price granularity).

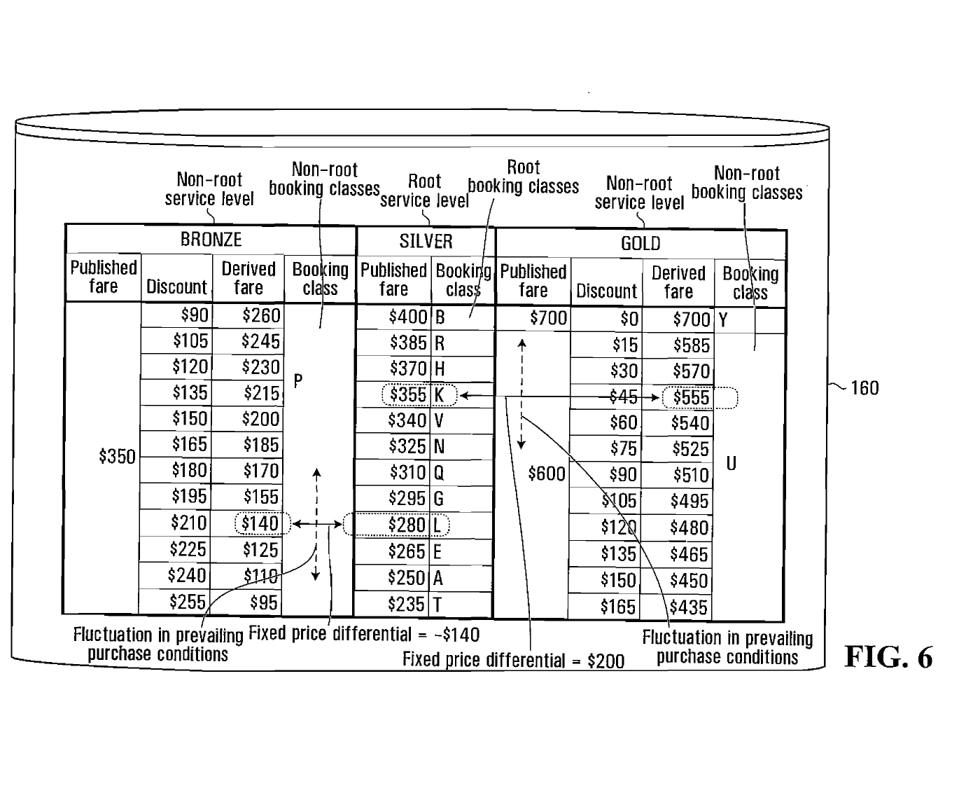

It should therefore be appreciated that a mapping exists whereby each of the non-root booking classes is associated with one or more “equivalent” root booking classes for that non-root booking class. As shown in FIG. 6, it is convenient to use a table of logical records to represent this mapping for a given flight. The table of logical records may be stored in a fare database 160 for the given flight.

In this specific non-limiting example of the fare database shown in FIG. 6, it is seen that the root service level is “silver” with twelve (12) root booking classes (B, R, H, K, V, N, Q, G, L, E, A, T). Each root booking class is associated with a respective published fare (ranging from $400 down to $235).

It will be noted that a first non-root service level is “bronze”, which is deemed to be “lower” than the root service level of “silver”. It is seen that the “bronze” non-root service level has a single non-root booking class (P) which is associated with a single published fare ($350). However, there are twelve derived fares (ranging from $260 down to $95) associated with the single non-root booking class (P), one for each of twelve (12) equivalent root booking classes (B, R, H, K, V, N, Q, G, L, E, A, T).

In an analogous fashion, it will be noted that a second non-root service level is “gold”, which is deemed to be “higher” than the root service level of “silver”. It is seen that the “gold” non-root service level has two (2) non-root booking classes (Y, U) which are associated with respective published fares ($700, $600). While there is one derived fare ($700) associated with the non-root booking class (Y), there are eleven (11) derived fares (ranging from $585 down to $435) associated with the non-root booking class (U), that is, one for each of eleven (11) equivalent root booking classes (R, H, K, V, N, Q, G, L, E, A, T).

The derived fare associated with a given non-root booking class and a given equivalent root booking class is computed by applying a discount to the published fare associated with the given non-root booking class. The actual amount of the discount depends on the published fare associated with the equivalent root booking class. Thus, it is possible to achieve the scenario where the difference between the published fare for a given root booking class and any derived fare associated with a non-root booking class for which the equivalent root booking class is the given root booking class, is kept constant as one migrates among root booking classes as a function of the purchase conditions prevailing at the time of purchase. In other words, a “fixed price differential” can be maintained between the fare quoted to the user at the root service level and the fare quoted to the user at a given non-root service level, regardless of the purchase conditions prevailing at the time of purchase. It is noted that the fixed price differential can be positive or negative, depending on whether the given non-root service level is higher or lower than the root service level. Naturally, a different fixed price differential can be used for each non-root service level. For example, in the non-limiting embodiment of FIG. 6, the fixed price differential between the “bronze” and “silver” service levels is −$140, while the fixed price differential between the “silver” and “gold” service levels is $200.

As a result of the above, during the purchase of air travel services, the airline can offer the user a degree of price predictability when considering the migration between two service levels. Specifically, the present technique allows the airline to honour a fixed price differential, irrespective of the purchase conditions prevailing at the time of purchase. Meanwhile, the airline does not need to change the way that it advertises fares, that is, it can continue to send published fares and associated booking classes to the fare gathering and redistribution entity in the traditional manner.

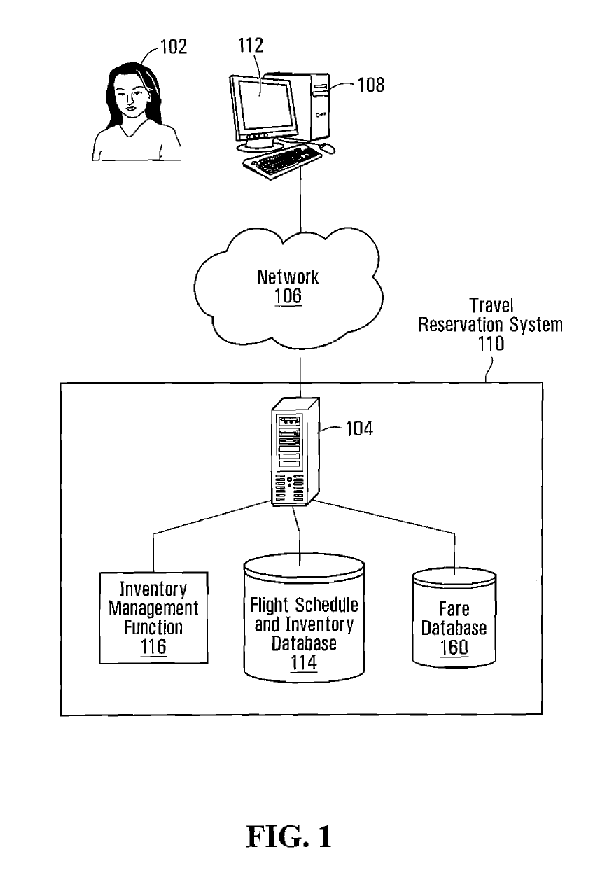

With reference to FIG. 1, a non-limiting process for vending air travel services to a user 102 will now be described in the context of a travel services architecture comprising a travel reservation system 110 including a server 104 that is accessible over a network 106. The server 104 acts as a gateway between a computing apparatus 108 connected to the network 106 and a remainder of the travel reservation system 110.

The computing apparatus 108 and the network 106 are not particularly limited to any specific implementation. For example, the network 106 may comprise a portion of the public switched telephone network, a public data network (such as the Internet), a private data network (such as Galileo, Sabre, etc.), a wireless network, etc. Also, the computing apparatus 108 may be a desktop PC, a laptop, a smart phone, a networked wireless personal communication device (such as Treo, BlackBerry, etc.), and so on.

The computing apparatus 108 is configured to execute a client software application adapted to interact with the server 104. The software application may be a web browser or a customized program designed specifically to communicate with the server 104. The server 104 is configured to cause the software application to run a graphical user interface (GUI) 112 for the server 104. The server 104 cooperates with the GUI 112 running on the computing apparatus 108, to allow the user 102 to convey information to the remainder of the travel reservation system 110, and to allow information from the remainder of the travel reservation system 110 to be conveyed to the user 102.

In addition to comprising the server 104, the travel reservation system 110 comprises the requisite functional components to allow a seat or seats to be booked on a desired flight or flights based on interaction with the user 102. To this end, the travel reservation system 110 includes, among other components and in addition to the aforesaid fare database 160, a flight schedule and inventory database 114 and an inventory management function 116.

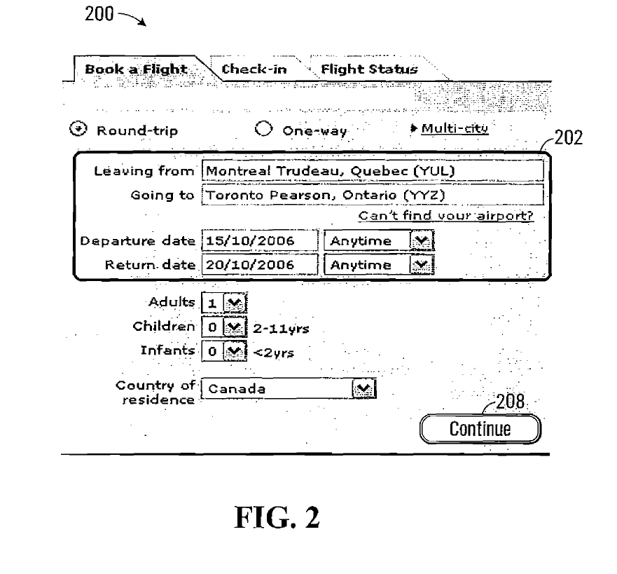

With reference now to FIG. 2, there is shown an example of a graphical element 200 displayed by the GUI 112 running on the computing apparatus 108. The graphical element 200, hereinafter referred to as an “introductory page”, allows the user 102 to convey air travel parameters. To this end, the introductory page 200 comprises a region 202 that permits the user 102 to enter, for example, origin and destination information (such as by city name or airport code), as well as schedule information (such as a departure date and a return date). Of course, other regions may be provided on the introductory page 200 (and/or other pages provided), thereby allowing additional air travel parameters to be specified, without departing from the spirit of the present invention. Such additional air travel parameters may include, without limitation: a number of passengers, a specific airline, a country of residence, a range of dates instead of a specific date, whether the trip is one-way or return, etc.

The introductory page 200 further comprises a user selection conveyance mechanism 208 (e.g., button, hyperlink, arrow, etc.) that can be actioned by the user 102 via an appropriate input device (e.g., mouse, keyboard, stylus, touch sensitive input screen, speech recognition utility). When the user selection conveyance mechanism 208 is so actioned, this event is detected by the server 104, which then initiates a search in a flight schedule and inventory database 114 of the travel reservation system 110 for availability of a seat on a flight (or sequence of flights) that meets the air travel parameters specified by the user 102. There may be more than one flight (or more than one sequence of flights) meeting the air travel parameters specified by the user 102. Where the travel parameters specify a return trip, a separate set of one or more flights (or sequences of flights) may exist for each of two “origin-destination segments”.

Assuming the existence of at least one flight for each origin-destination segment on which the requisite number of seat(s) is available, the travel reservation system 110 returns to the server 104 certain flight information related to each flight, including a confirmation of the origin and destination, as well as flight time, flight number, aircraft data, connections, etc. In addition, the travel reservation system 110 may or may not temporarily reserve the requisite number of seat(s) on each flight, for each origin-destination segment.

In addition, the travel reservation system 110 returns to the server 104 certain price information related to each flight. The price information related to a given flight comprises one or more price points related to the given flight, each associated with a respective service level, in this case from the set of “bronze”, “silver” and “gold”. The price point associated with a given service level and related to a given flight indicates the price to be charged to the user 102 for air travel on the given flight, at the given service level.

The one or more price points related to the given flight correspond to the fares that are stored in the fare database 160 for the given flight. More specifically, and according to a non-limiting embodiment of the present invention, the one or more price points related to the given flight correspond to the fares in a single row of the table in the fare database 160 for the given flight, as can be seen in FIG. 6.

Exactly which row is applicable will depend on the purchase conditions prevailing at the time of purchase. In this example, the applicable row will contain one published fare (corresponding to the root booking class) and two derived fares (corresponding to the two non-root booking classes). Thus, one published fare and two derived fares are returned to the server 104. It is noted that the server 104 need not know which of the three price points returned by the fare database 160 is the published fare and which are derived fares. All three will appear to the user 102 simply as price points for travel on the given flight at different respective service levels.

It is noted that although different rows of the table in the fare database 160 for the given flight will be applicable under different purchase conditions, the difference in the price points between two different service levels is constant (i.e., it corresponds to the aforesaid “fixed price differential”) regardless of such purchase conditions. This allows for greater price predictability from the user's perspective, which may have beneficial effects. For instance, the airline can advertise the fixed price differential in advance, thereby to give the user 102 a priori knowledge of the fixed price differential. This, in turn, may have the effect of causing the user 102 to feel that he or she has a greater flexibility in effecting service level changes.

The above process of obtaining price information is repeated for each other flight (if applicable), for each origin-destination segment, by accessing a similar fare database for each such other flight, thereby to produce the requisite price information.

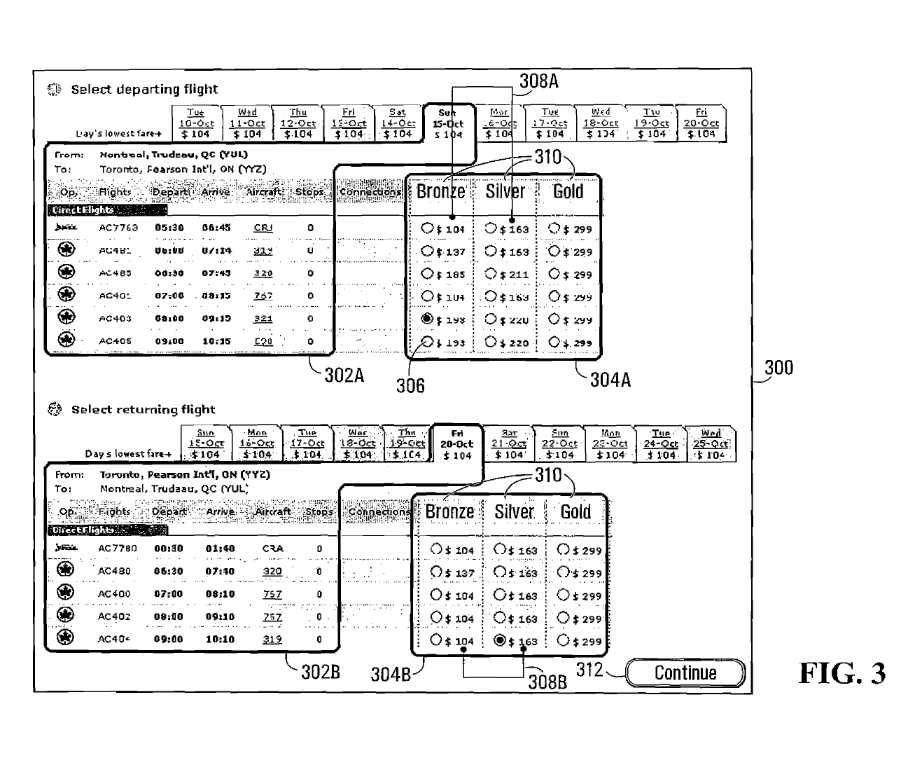

Based on the flight information and price information from received from the travel reservation system 110, the server 104 changes the page displayed by the GUI 112 running on the computing apparatus 108. Specifically, with reference to FIG. 3, a graphical element 300 is displayed, hereinafter referred to as a “select page”. The select page 300 may comprise a region 302A that displays the flight information related to each flight for an outbound origin-destination segment, and a region 302B that displays the flight information related to each flight for an inbound origin-destination segment. The information displayed in regions 302A and 302B includes the respective origin and destination, as well as flight times, flight numbers, aircraft data, connections, etc. For convenience, and in accordance with a specific non-limiting embodiment, the flight information for each origin-destination segment may be displayed in the form of a matrix, where each row of the matrix is associated with a respective flight for the origin-destination segment in question.

The select page 300 may further comprise a region 304A that displays the price information related to each flight for the outbound origin-destination segment, and a region 304B that displays the price information related to each flight for the inbound origin-destination segment. In a non-limiting example embodiment, where the flight information is displayed in each of the regions 302A, 302B as a corresponding matrix of rows associated with respective flights, each of the regions 304A, 304B displays one or more price points per row of the corresponding matrix. It is recalled that each price point is associated with a given service level, in addition to being related to a given flight for a given origin-destination segment. Accordingly, in a non-limiting embodiment, the division between service levels can be made evident by utilizing different columns of the corresponding matrix.

In addition, the select page 300 comprises a mechanism that permits the user 102 to specify an available combination of flight and service level, for each origin-destination segment. In a specific non-limiting embodiment, this may be achieved by providing a radio button 306 (or check box, etc.) in the vicinity of each price point in the regions 304A, 304B. For each origin-destination segment, the user 102 may be permitted to select only one price point. Thus, as is the case in the present non-limiting example, where there are two origin-destination segments, the user 102 may be permitted to select only one price point (i.e., one combination of flight and service level) per origin-destination segment. However, it is contemplated that in other embodiments, the user 102 may be permitted to select multiple price points.

The price point selected for the outbound origin-destination segment is hereinafter referred to as an “original outbound price point”, while the associated flight is hereinafter referred to as an “original outbound flight”, and the associated service level is hereinafter referred to as an “original outbound service level”. Analogously, the price point selected for the inbound origin-destination segment is hereinafter referred to as an original inbound price point, while the associated flight is hereinafter referred to as an “original inbound flight”, and the associated service level is hereinafter referred to as an “original inbound service level”. Naturally, the original outbound service level and the original inbound service level may be the same.

Additionally, the select page 300 comprises a region 308A that displays “quantitative service level change information”, which indicates the difference between the original outbound price point and the price point associated with at least one service level other than the original outbound service level, and related to the original outbound flight (and possibly other flights for the outbound origin-destination segment). In one embodiment, the region 308A may comprise the region 304A, in which case the quantitative service level change information can take the form of a continued display of the price point(s) associated with the other service level(s), and related to the original outbound flight (or other flights for the outbound origin-destination segment). In another embodiment, the quantitative service level change information can take the form of an explicit display of the aforesaid fixed price differential, which is the difference between the original outbound price point and the price point associated with at least one of the other service level(s), and related to the original outbound flight (and possibly other flights for the outbound origin-destination segment).

Analogously, the select page 300 comprises a region 308B that displays quantitative service level change information, which indicates the difference between the original inbound price point and the price point associated with at least one service level other than the original inbound service level, and related to the original inbound flight (and possibly other flights for the inbound origin-destination segment). In one embodiment, the quantitative service level change information can take the form of a continued display of the price point(s) associated with the other service level(s), and related to the original inbound flight (or other flights for the inbound origin-destination segment). In another embodiment, the quantitative service level change information can take the form of an explicit display of the aforesaid fixed price differential, which is the difference between the original inbound price point and the price point associated with at least one of the other service level(s), and related to the original inbound flight (and possibly other flights for the inbound origin-destination segment).

Continuing with FIG. 3, the select page 300 may also comprise a region 310 that displays qualitative service level change information. The qualitative service level change information may be displayed persistently or only when the user 102 accesses (e.g., by passing over or clicking) the region 310. The qualitative service level change information may comprise non-price-related information that concerns at least one service level other than either the original outbound service level or the original inbound service level. In one specific non-limiting embodiment, the qualitative service level change information may comprise a comparative listing of the core service attributes in the first and original inbound service levels and in the other service level(s). In another specific non-limiting embodiment, the qualitative service level change information may comprise a list of core service attributes available in the other service level(s) but not in the first or original inbound service levels. In another specific non-limiting embodiment, the qualitative service level change information may comprise a list of privileges available in the other service level(s) but not in the first or original inbound service levels. Combinations of the foregoing may be used in still further non-limiting embodiments.

It should be noted that the user 102 continues to be free to change the original outbound service level and/or the original inbound service level, and in fact remains free to selected an entirely different flight for each origin-destination segrnent. In view of this flexibility provided by the select page 300, let the price point ultimately selected for the outbound origin-destination segment be hereinafter referred to as a “final outbound price point”, with the associated flight being hereinafter referred to as a “final outbound flight”, and the associated service level being hereinafter referred to as a “final outbound service level”. Analogously, let the price point ultimately selected for the inbound origin-destination segment be hereinafter referred to as a “final inbound price point”, with the associated flight being hereinafter referred to as a “final inbound flight”, and the associated service level being hereinafter referred to as a “final inbound service level”. Naturally, the final outbound service level and the final inbound service level may be the same.

The select page 300 further comprises a user selection conveyance mechanism 312 (e.g., button, hyperlink, arrow, etc.) that can be actioned by the user 102 via an appropriate input device (e.g., mouse, keyboard, stylus, touch sensitive input screen, speech recognition utility). When the user selection conveyance mechanism 312 is so actioned, this event is detected by the server 104, which then effects a reservation in the flight schedule and inventory database 114 of the travel reservation system 110, in accordance with (i) the final outbound flight and the final outbound service level; and (ii) the final inbound flight and the final inbound service level.

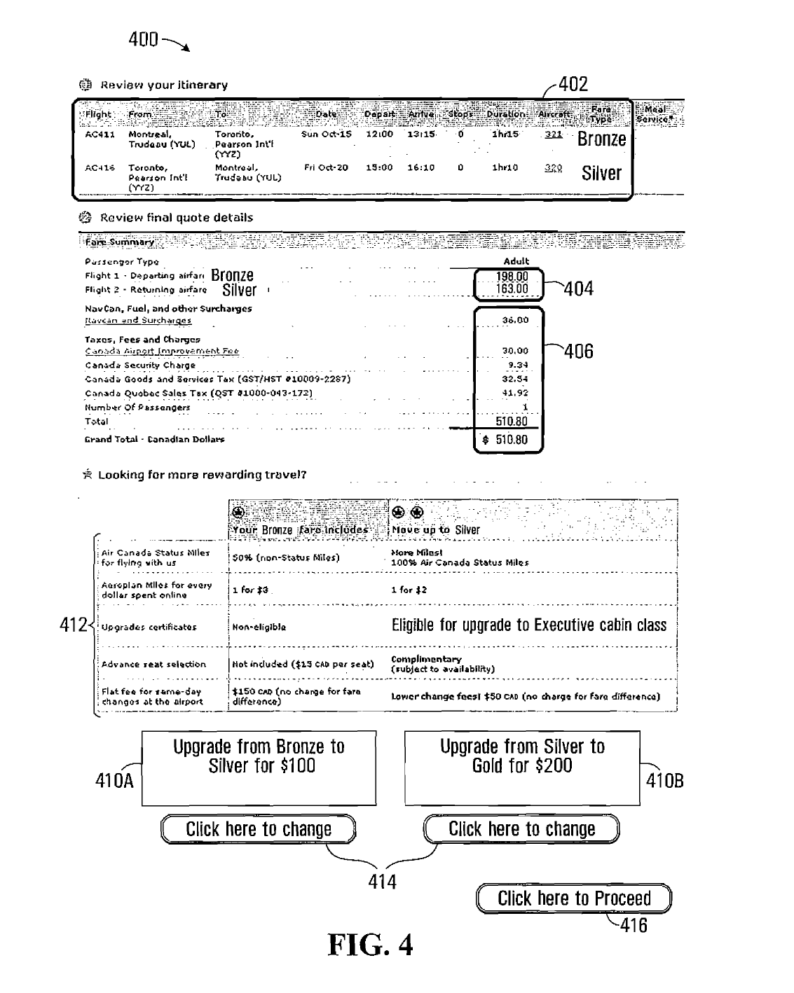

Based on the information from received from the travel reservation system 110, the server 104 changes the page displayed by the GUI 112 running on the computing apparatus 108. Specifically, with reference to FIG. 4, a graphical element 400 is displayed, hereinafter referred to as a “review page”. The review page 400 may comprise a region 402 that displays the flight information related to the final flight for each origin-destination segment. The review page 400 may also comprise a region 404 that displays (i) the final outbound price point, which is associated with the final outbound service level and related to the final outbound flight; and (ii) the final inbound price point, which is associated with the final inbound service level and related to the final inbound flight.

The review page 400 may further comprise a region 406 that displays ancillary financial data such as taxes, surcharges, grand total, etc. In addition, the review page 400 may further comprise a region 410A that displays quantitative service level change information, indicating the difference between the final outbound price point and the price point associated with at least one service level other than the final outbound service level, and related to the final outbound flight. In this case, the quantitative service level change information 410A indicates that an upgrade from “bronze” to “silver” can be effected by paying a surcharge of $100, but this example is of course not to be considered limiting. Additionally, it may be possible to downgrade to a “lower” service level for a credit, or the option may be given to upgrade or downgrade, for various amounts of surcharge or credit.

The review page 400 may further comprise a region 410B that displays quantitative service level change information, indicating the difference between the final inbound price point and the price point associated with at least one service level other than the final inbound service level, and related to the final inbound flight. In this case, the quantitative service level change information 410B indicates that an upgrade from “silver” to “bronze” can be effected by paying a surcharge of $200, but this example is of course not to be considered limiting. Additionally, it may be possible to downgrade to a “lower” service level for a credit, or the option may be given to upgrade or downgrade, for various amounts of surcharge or credit.

In addition, the review page 400 may further comprise a region 412 that displays qualitative service level change information that concerns at least one service level other than the final outbound service level or the final inbound service level.

The review page 400 further comprises a service level change conveyance mechanism 414 (e.g., button, hyperlink, arrow, etc.) that can be actioned by the user 102 via an appropriate input device (e.g., mouse, keyboard, stylus, touch sensitive input screen, speech recognition utility). The service level change conveyance mechanism 414 allows the user 102 to effect a last-minute service level change relative to the final outbound service level and/or the final inbound service level. When the service level change conveyance mechanism 414 is so actioned, this event is detected by the server 104, which then causes the review page 400 to be redisplayed, along with the regions 402, 404, 406, 410A, 410B and 414, updated to reflect the chang(s) made to the final outbound and/or inbound service level.

The review page 400 may further comprise a purchase conveyance mechanism 416 (e.g., button, hyperlink, arrow, etc.) that can be actioned by the user 102 via an appropriate input device (e.g., mouse, keyboard, stylus, touch sensitive input screen, speech recognition utility). When the purchase conveyance mechanism 416 is so actioned, this event is detected by the server 104, which then causes a seat reservation to be made on an outbound flight using the flight schedule and inventory database 114 of the travel reservation system 110, in accordance with the final outbound flight and the final outbound service level. In addition, the server 104 causes a seat reservation to be made on an inbound flight using the flight schedule and inventory database 114 of the travel reservation system 110, in accordance with the final inbound flight and the final inbound service level. In addition, actioning of the purchase conveyance mechanism 416 initiates a financial transaction, e.g., via conventional or e-commerce means. The aforesaid seat reservations may be held for a fixed minimum amount of time to allow the financial transaction to be confirmed.

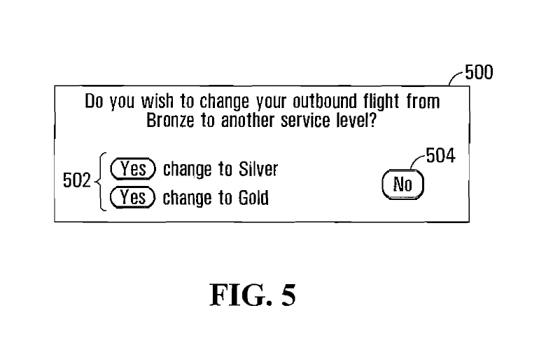

In addition, or alternatively, prior to effecting the financial transaction in response to actioning of the purchase conveyance mechanism 416, the server 104 may change the page displayed by the GUI 112 running on the computing apparatus 108. Specifically, with reference to FIG. 5, a graphical element 500 may be displayed (e.g., a dialog box superimposed onto the review page 400 or in a separate window), which prompts the user 102 to confirm the transaction and, in addition, provides the user 102 with a final opportunity to effect a service level change. Specifically, in this non-limiting embodiment, the graphical element 500 comprises a service level change conveyance mechanism 502 and a no service level change conveyance mechanism 504 (e.g., buttons, hyperlinks, arrows, etc.) that can be actioned by the user 102 via an appropriate input device (e.g., mouse, keyboard, stylus, touch sensitive input screen, speech recognition utility).

The service level change conveyance mechanism 502 may indicate various other service levels for which a price point is available, for the final outbound flight (shown) as well as for the final inbound flight (not shown). In this way, the service level change conveyance mechanism 502 allows the user 102 to effect a last-minute service level change relative to the final outbound service level and/or the final inbound service level. Alternatively, the presence of the service level change conveyance mechanism 502 combined with the presence of the no service level change conveyance mechanism 504 in the same dialog box can be viewed as a manner of compelling the user 102 to actively render a decision as to whether or not to make a service level change.

When the service level change conveyance mechanism 502 is so actioned, this event is detected by the server 104, which prevents the financial transaction from taking place and causes the aforesaid review page 400 to be redisplayed, along with the regions 402, 404, 406, 410A, 410B and 414. On the other hand, actioning of the no service level change conveyance mechanism 504, when detected by the server 104, allows the financial transaction to proceed in the previously described manner, e.g., by conventional or c-commerce means.

Upon confirmation of the financial transaction effected subsequent to actioning of the purchase conveyance mechanism 416 (and, if applicable, subsequent actioning of the no service level change conveyance mechanism 504), the travel reservation system 110 issues one or more tickets.

In view of the above, and as will be appreciated by persons skilled in the art, embodiments of the present invention afford an airline the flexibility to offer a wide range of booking classes (and price points) adapted to various purchase conditions, while at the same time demonstrating transparency vis-à-vis the user 102, having demystified the price dynamics of a service level change, and in some cases having reduced such dynamics to a fixed price differential. Meanwhile, the airline may continue to publish twenty-six (26) or fewer fares per flight.

It should also be appreciated that it is within the scope of the invention to provide different fixed price differentials that apply to different origin-destination segments. For instance, short-haul flights and long-haul flights may be associated with different respective fixed price differentials.

In addition, it should be appreciated that the airline may modify the fixed price differential without having to alert the fare gathering and redistribution entity. All that is required is a recalculation of the discounts using a different value for the fixed price differential.

Persons skilled in the art will appreciate that in some embodiments, the functionality of the server 104 and various other functional elements of the travel reservation system 110 may be implemented using pre-programmed hardware or firmware elements (e.g., application specific integrated circuits (ASICs), electrically erasable programmable read-only memories (EEPROMs), etc.), or other related components. In other embodiments, the functionality of the server 104 and various other functional elements of the travel reservation system 110 may be achieved using a computing apparatus that has access to a code memory (not shown) which stores computer-readable program code for operation of the computing apparatus. The computer-readable program code could be stored on a medium which is fixed, tangible and readable directly by server 104 and various other functional elements of the travel reservation system 110, (e.g., removable diskette, CD-ROM, ROM, fixed disk, USB drive), or the computer-readable program code could be stored remotely but transmittable to the server 104 and various other functional elements of the travel reservation system 110 via a modem or other interface device (e.g., a communications adapter) connected to a network (including, without limitation, the Internet) over a transmission medium. The transmission medium may be either a non-wireless medium (e.g., optical or analog communications lines) or a wireless medium (e.g., microwave, infrared or other transmission schemes) or a combination thereof.

While specific embodiments of the present invention have been described and illustrated, it will be apparent to persons skilled in the art that numerous modifications and variations can be made without departing from the scope of the invention as defined in the appended claims.

1. A computer-implemented method of vending air travel services, comprising:
determining a plurality of published fares each associated with a respective one of a plurality of root booking classes, said published fares being applicable to the purchase of air travel at a root service level;
determining a plurality of derived fares each associated with a respective equivalent booking class that is one of the root booking classes, said derived fares being applicable to the purchase of air travel at a non-root service level, the derived fare for which the equivalent booking class is a particular one of the root booking classes being computed from the published fare associated with the particular one of the root booking classes by applying a price differential that is common across multiple ones of the root booking classes;
offering the sale of air travel at a plurality of price points that includes at least a first one of the published fares and at least a first one of the derived fares, wherein the equivalent booking class associated with said first one of the derived fares corresponds to the root booking class associated with said first one of the published fares.

2. The method defined in claim 1, wherein the price differential is a function of the root service level and the non-root service level.

3. The method defined in claim 2, further comprising selecting the plurality of price points at which the sale of air travel is offered, said selecting being executed based on prevailing purchase conditions.

4. The method defined in claim 3, further comprising providing the plurality of published fares to a gathering and redistribution entity in association with a respective one of the root booking classes.

5. The method defined in claim 4, wherein the number of published fares is less than twenty-six and wherein the sum of the number of published fares and the number of derived fares exceeds twenty-six.

6. The method defined in claim 5, wherein the root service level and the non-root service level are each associated with a different respective set of core service attributes.

7. The method defined in claim 6, wherein the root service level and the non-root service level are each associated with a different respective set of air travel privileges.

8. The method defined in claim 7, wherein the first and second service levels pertain to service offered in the same cabin class.

9. The method defined in claim 1, wherein said offering the sale is executed over a communications network.

10. A computer-readable medium comprising computer-readable program code which, when interpreted by a computing apparatus, causes the computing apparatus to execute the method of claim 1.

11. A computing device suitable for use in facilitating the purchase of air travel services, the computing device comprising:
means for determining a plurality of published fares each associated with a respective one of a plurality of root booking classes, said published fares being applicable to the purchase of air travel at a root service level;
means for determining a plurality of derived fares each associated with a respective equivalent booking class that is one of the root booking classes, said derived fares being applicable to the purchase of air travel at a non-root service level, the derived fare for which the equivalent booking class is a particular one of the root booking classes being computed from the published fare associated with the particular one of the root booking classes by applying a price differential that is common across multiple ones of the root booking classes;
means for offering the sale of air travel at a plurality of price points that includes at least a first one of the published fares and at least a first one of the derived fares, wherein the equivalent booking class associated with said first one of the derived fares corresponds to the root booking class associated with said first one of the published fares.

12. A database suitable for use in the vending of air travel services on a given flight, said database comprising a plurality of logical records storing data pertaining to a first service level and data pertaining to a second service level, wherein:
the data pertaining to the first service level conveys information indicative of:
a respective published fare provided to a gathering and redistribution entity in association with a respective one of a plurality of root booking classes for the given flight;
the respective published fare being applicable to the purchase of air travel on the given flight at the first service level;
the data pertaining to the second service level conveys information indicative of:
a respective equivalent root booking class that is one of said plurality of root booking classes;
a respective derived fare;
a corresponding second published fare provided to a gathering and redistribution entity in association with a corresponding non-root booking class for the given flight;
the respective derived fare being applicable to the purchase of air travel on the given flight at the second service level; the respective derived fare being derived from the corresponding second published fare by applying a price adjustment that is a function of the respective equivalent root booking class.

13. The database defined in claim 12, wherein each of the logical records is associated with respective purchase conditions.

14. A travel reservation system comprising the database defined in claim 12.

15. A computer-implemented method of vending air travel services, comprising:
receiving air travel parameters from a user;
identifying at least one flight that is in accordance with the air travel parameters;
providing the user with an opportunity to purchase a ticket for at least one of said at least one flight at either a respective first fare associated with a first service level or a respective second fare associated with a second service level;
wherein the respective first and respective second fares are selected from a database of fares as a function of prevailing purchase conditions;
wherein the respective first and respective second fares differ by an amount that is independent of the prevailing purchase conditions.

16. The method defined in claim 15, wherein the air travel parameters include at least one of (I) origin information; (II) destination information and (III) schedule information.

17. The method defined in claim 16, wherein providing the user with an opportunity to purchase the ticket for a given one of the at least one flight comprises causing a graphical element to be displayed on a computing device used by the user, said graphical element conveying the respective first and second fares and comprising an actionable region to allow the user to convey an intent to purchase the ticket for the given one of the at least one flight at either the respective first or the respective second fare.

18. The method defined in claim 17, further comprising selecting the respective first and respective second fares from said database of fares as a function of prevailing purchase conditions.

19. The method defined in claim 18, further comprising informing the user of said amount prior to said identifying, thereby to give the user a priori knowledge of said amount.

20. The method defined in claim 19, wherein the first and second service levels are associated with different respective sets of core service attributes.

21. The method defined in claim 20, wherein the first and second service levels are associated with different respective sets of air travel privileges.

22. The method defined in claim 21, wherein the first and second service levels pertain to service offered in the same cabin class.

23. The method defined in claim 22, wherein the graphical element comprises a page.

24. A computer-readable medium comprising computer-readable program code which, when interpreted by a computing apparatus, causes the computing apparatus to execute the method of claim 15.

25. A system for vending air travel services, comprising:
means for receiving air travel parameters from a user;
means for identifying at least one flight that is in accordance with the air travel parameters;
means for providing the user with an opportunity to purchase a ticket for at least one of said at least one flight at either a respective first fare associated with a first service level or a respective second fare associated with a second service level;
wherein the respective first and respective second fares are selected from a database of fares as a function of prevailing purchase conditions;
wherein the respective first and respective second fares differ by an amount that is independent of the prevailing purchase conditions.

26. A method of vending air travel services, comprising:
determining for a given flight a plurality of published fares respectively associated with a plurality of booking classes, said published fares being applicable to the purchase of air travel on the given flight under different purchase conditions associated with the plurality of booking classes;
offering the sale of air travel on the given flight at a number of price points that exceeds the number of published fares in said plurality of published fares.

27. The method defined in claim 26, further comprising:
providing to a fare gathering and redistribution entity said plurality of published fares in association with the given flight.

28. The method defined in claim 27, wherein the number of price points is greater than twenty-six.

29. The method defined in claim 28, wherein a first subset of said price points is associated with a first service level, wherein a different subset of said price points are associated with a second service level different from the first service level.

30. The method defined in claim 29, wherein each of the price points in said first subset of said price points corresponds to a respective one of said published fares and wherein at least one of the price points in said second subset of said price points does not correspond to any of said published fares.

31. The method defined in claim 30, wherein the first and second service levels are associated with different respective sets of core service attributes.

32. The method defined in claim 31, wherein the first and second service levels are associated with different respective sets of air travel privileges.

33. The method defined in claim 32, wherein the first and second service levels pertain to service offered in the same cabin class.

34. The method defined in claim 26, wherein said offering for sale is executed over a communications network.

35. A computer-readable medium comprising computer-readable program code which, when interpreted by a computing apparatus, causes the computing apparatus to execute the method of claim 26.

36. A computer-implemented method of vending air travel services, comprising:
receiving air travel parameters from a user;
identifying a flight that is in accordance with the air travel parameters;
providing the user with an opportunity to make a first decision, said first decision being a decision to purchase a ticket for said flight at either a first fare associated with a first service level or a second fare associated with a second service level;
responsive to said user conveying an intent to purchase a ticket for said flight at the first service level, compelling the user to make a second decision, said second decision being a decision to accept or reject an opportunity to purchase a ticket for said flight at the second service level instead of at the first service level;
selling the ticket at the first fare or the second fare as a function of an outcome of the second decision.

37. The method defined in claim 36, wherein the air travel parameters include at least one of (I) origin information; (II) destination information and (III) schedule information.

38. The method defined in claim 37, wherein providing the user with an opportunity to make the first decision comprises causing a graphical element to be displayed on a computing device used by the user, said graphical element conveying the first and second fares and comprising an actionable region to allow the user to convey an outcome of the first decision.

39. The method defined in claim 38, wherein compelling the user to make a second decision comprises causing a second graphical element to be displayed on the computing device used by the user, said second graphical element conveying at least one of quantitative service level change information and qualitative service level change information, and comprising an actionable region to allow the user to convey the outcome of the second decision.

40. The method defined in claim 39, wherein the first and second service levels are associated with different respective sets of core service attributes.

41. The method defined in claim 40, wherein the first and second service levels are associated with different respective sets of air travel privileges.

42. The method defined in claim 41, wherein the first and second service levels pertain to service offered in the same cabin class.

43. The method defined in claim 42, wherein the first graphical element comprises a page and wherein the second graphical element comprises a dialog box.

44. The method defined in claim 36, wherein said selling the ticket comprises an exchange of consideration over a communications network.

45. A computer-readable medium comprising computer-readable program code which, when interpreted by a computing apparatus, causes the computing apparatus to execute the method of claim 36.

46. A computing device suitable for use in facilitating the purchase of air travel services by a user, the computing device comprising:
means for receiving air travel parameters from a user;
means for identifying a flight that is in accordance with the air travel parameters;
means for providing the user with an opportunity to make a first decision, said first decision being a decision to purchase a ticket for said flight at either a first fare associated with a first service level or a second fare associated with a second service level;
means responsive to said user conveying an intent to purchase a ticket for said flight at the first service level, for compelling the user to make a second decision, said second decision being a decision to accept or reject an opportunity to purchase a ticket for said flight at the second service level instead of at the first service level;
means for selling the ticket at the first fare or the second fare as a function of an outcome of the second decision.
